(19) United States
(12) Patent Application Publication
(10) Pub. No.: US 2026/0166897 A1
(43) Pub. Date: Jun. 18, 2026

(54) RECORDING DEVICE

(71) Applicant: CANON KABUSHIKI KAISHA, Tokyo (JP)

(72) Inventor: ATSUSHI UETA, Kanagawa (JP)

(21) Appl. No.: 19/387,989

(22) Filed: Nov. 13, 2025

(30) Foreign Application Priority Data
Dec. 18, 2024 (JP) 2024-221877

(51) Int. Cl. B41J 15/04; B41J 11/00; B41J 11/70; B41J 29/02

(52) U.S. Cl. CPC B41J 15/04; B41J 11/009; B41J 11/70; B41J 29/02

(57) ABSTRACT

Used is a recording device including a recording unit that records an image on a recording medium drawn out from a roll, an ejection port through which the recording medium on which an image is recorded by the recording unit is ejected, a sheet-like receiving member that receives the recording medium ejected from the ejection port, a moving mechanism that moves the receiving member to a first position at which the receiving member receives the recording medium and a second position at which the receiving member does not receive the recording medium, and a control unit that performs control to move the receiving member to the first position and the second position by the moving mechanism.

### BACKGROUND

### Field of the Technology

The present disclosure relates to a recording device.

### Description of the Related Art

In a recording device, such as a printer, that uses roll paper as a recording medium, a configuration has been known in which an ejected sheet receiving unit, such as a sheet basket structure or a tray, is provided to hold a recording medium on which an image has been recorded. A recording device described in Japanese Patent Laid-Open No. 2022-057441 includes an ejected sheet receiving unit that receives a recording medium on which an image has been recorded. The ejected sheet receiving unit is configured to be drawn out from a device body and receive an ejected sheet, when image recording is performed, and when the image recording is not performed, to be accommodated in an accommodating unit in the device. This makes it possible to avoid accumulation of dust and dirt on the ejected sheet receiving unit.

However, according to the configuration of Japanese Patent Laid-Open No. 2022 057441, there may be a case where, due to an operation by a person, the ejected sheet receiving unit is not drawn out from the inside of the device or the ejected sheet receiving unit is insufficiently drawn out. When the image recording is performed in such a state, there is a possibility that an ejected recording medium falls on a floor or comes into contact with another device or object. As a result, the recording medium may be contaminated or scratched.

### SUMMARY

The present disclosure has been made to solve the above problem. The present disclosure is directed to provide a recording device in which an ejected sheet receiving unit that receives a recording medium that has been ejected is moved by drive.

The present disclosure provides a recording device comprising:

a recording unit configured to record an image on a recording medium drawn out from a roll;

an ejection port through which the recording medium on which an image is recorded by the recording unit is ejected;

a sheet-like receiving member configured to receive the recording medium ejected from the ejection port;

a moving mechanism configured to move the receiving member to a first position at which the receiving member receives the recording medium and a second position at which the receiving member does not receive the recording medium; and

a control unit configured to perform control to move the receiving member to the first position and the second position by the moving mechanism.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic perspective views of a recording device during image non-recording according to a first embodiment.

FIGS. 2A and 2B are schematic perspective views of the recording device during image recording according to the first embodiment.

FIGS. 3A and 3B are schematic sectional views of the recording device according to the first embodiment.

FIGS. 4A to 4C are diagrams for explaining drawn-out positions according to the first embodiment.

FIG. 5 is a flowchart according to the first embodiment.

FIG. 6 is a block diagram illustrating hardware and control configurations according to the first embodiment.

FIGS. 7A and 7B are schematic sectional views of a recording device according to a second embodiment.

FIGS. 8A to 8C are schematic sectional views of front-side sheet ejection according to a third embodiment.

FIGS. 9A to 9C are schematic sectional views of another example of the front-side sheet ejection according to the third embodiment.

### DESCRIPTION OF THE EMBODIMENTS

Hereinafter, embodiments of the present disclosure will be described based on examples with reference to the drawings. However, the dimensions, materials, shapes, arrangements, and the like of the configurations and components described in the following embodiments should be appropriately changed according to various conditions and configurations of devices to which this disclosure is applied. That is, the scope of the disclosure is not limited to the following embodiments.

In the present disclosure, the terms “upper”, “lower”, “left”, “right”, “front”, “rear”, and the like are used for convenience in describing relative positional relations between members with reference to the drawings. Thus, positional relations in actual arrangements of devices are not limited by these terms.

Typically, the present disclosure is applicable to a recording device (image forming device) including an automatic ejected sheet receiving unit that receives a recording medium ejected after image recording, and a control method for the recording device. More specifically, the present disclosure is applicable to a recording device that optimally receives a recording medium by automatically operating an ejected sheet receiving unit according to a state (the type and remaining amount of the recording medium, for example) of the recording medium, and a method for controlling the recording device.

### First Embodiment

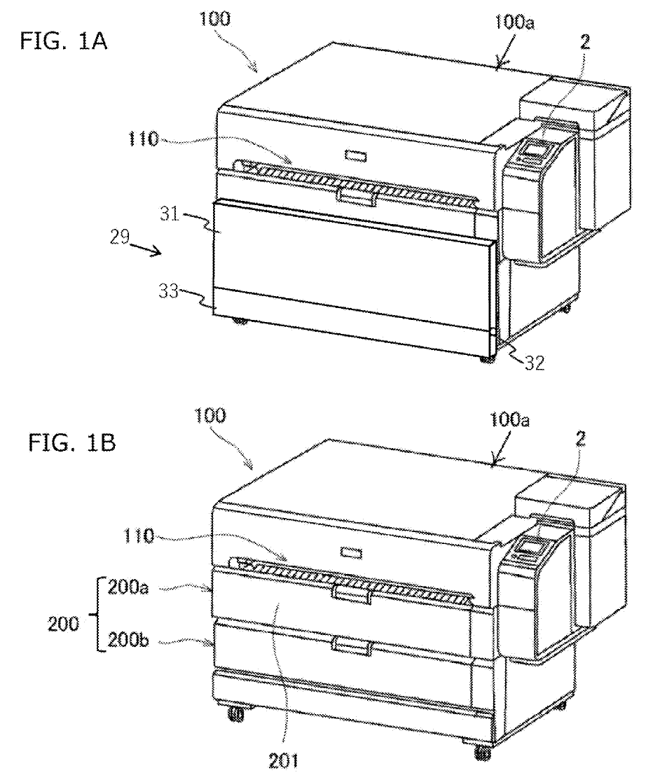

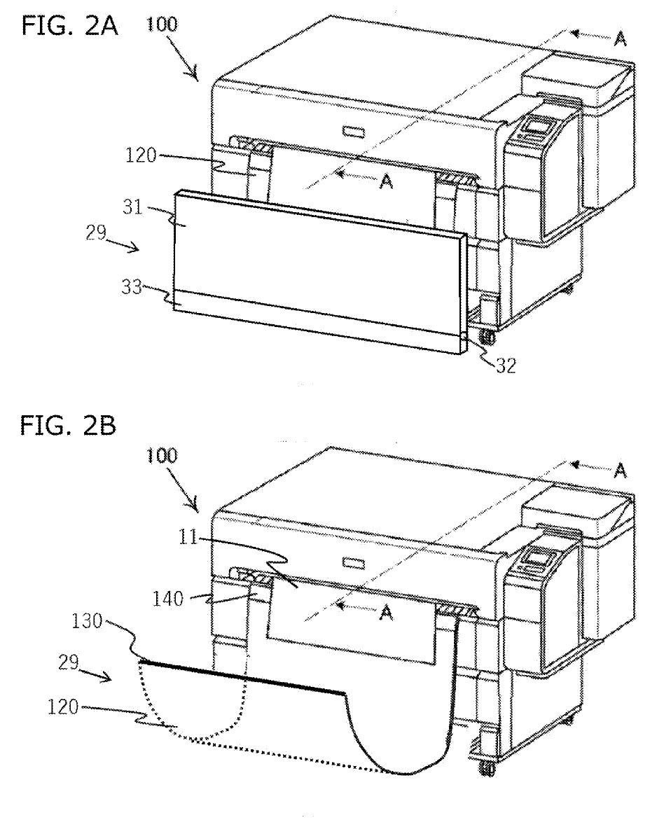

An image recording device (hereinafter, a recording device 100) according to the present embodiment is a device capable of setting two rolls R each obtained by winding, in a roll shape, a sheet 1 that is a recording medium. FIGS. 1A, 1B, 2A, and 2B are perspective views schematically illustrating the recording device 100. FIGS. 1A and 1B illustrate states during image non-recording in which the recording device 100 does not perform image recording. FIGS. 2A and 2B illustrate states during image recording in which the recording device 100 performs the image recording.

FIG. 1A illustrates an appearance during non-recording. A first front plate 31, a pivot shaft 32, and a second front plate 33 of an ejected sheet receiving unit 29 are exposed to a front surface of the device. In the present embodiment, a side of a device body 100a on which a sheet ejection unit 110 is located is referred to as the front surface.

FIG. 1B illustrates a state in which the first front plate 31, the pivot shaft 32, and the second front plate 33 of the ejected sheet receiving unit 29 are removed from the state of FIG. 1A. In FIG. 1B, a sheet feeding unit 200 is a sheet supplying device that sets the sheet 1 and feeds the sheet to a recording unit 400. The sheet 1 can be set by being arranged in an up-down direction in the sheet feeding unit 200 of the present embodiment. A sheet feeding unit on the upper side is designated as an upper sheet feeding unit 200a, and a sheet feeding unit on the lower side is designated as a lower sheet feeding unit 200b. In the specification, when it is not necessary to distinguish the two sheet feeding units, they are collectively denoted as the sheet feeding unit 200.

The positional relationship between the first front plate 31 and the second front plate 33 is usually fixed by a lock mechanism (not illustrated) When setting the roll R in the sheet feeding unit 200, a user unlocks the lock mechanism to pivot the first front plate 31 around the pivot shaft 32 and fall the first front plate 31 forward, thereby opening a roll cover 201 to be accessible to the sheet feeding unit 200.

As illustrated in FIG. 1B, the roll cover 201 is disposed on a front surface of the sheet feeding unit 200, and on each of the upper and lower feeding units. The roll cover 201 is pivotally provided with respect to the device body 100a. In a state in which the roll cover 201 is closed, the roll cover 201 is an exterior surface. When the roll R is set to the sheet feeding unit 200, the roll cover 201 is made open.

An operation panel 2 provided with various switches and a display is disposed above a front surface of the device. The user can execute various instructions using the operation panel 2, such as size designation of the sheet 1, online-offline switching, and command input to the recording device 100.

In the recording device 100, one of the two rolls R that are set in the sheet feeding unit 200 is selected, the sheet 1 is drawn out, and an image is recorded. The sheet 1 on which the image recording is completed is ejected from the sheet ejection unit 110 that is provided on a front surface portion of the recording device 100. The sheet ejection unit 110 serving as an ejection port is a front-side sheet ejection guide unit that is provided on a front side of the device body 100a. As will be described later with reference to FIGS. 2A and 2B, when the image recording is performed, the ejected sheet receiving unit 29 is drawn from the device body 100a together with a drawer unit 150.

FIG. 2A illustrates an appearance during the image recording, and the ejected sheet receiving unit 29 is drawn out from the device body 100a to expose a receiving member 120. FIG. 2B illustrates a state in which the first front plate 31, the pivot shaft 32, and the second front plate 33 of the ejected sheet receiving unit 29 are removed from the state of FIG. 2A.

The ejected sheet receiving unit 29 includes a first holding member 130, a second holding member 140, and the receiving member 120. The first holding member 130 is a bar-shaped member that holds one end side of the receiving member 120. The second holding member 140 is a bar-shaped member that holds the other end side of the receiving member 120 on a side closer to the recording device 100 than the first holding member 130 is. The receiving member 120 is made of, for example, sheet-like basket cloth having flexibility of polyester, and has a receiving surface that receives a recorded sheet 11.

The first holding member 130 is removably attached to the first front plate 31 in FIG. 2A. The second holding member 140 is removably attached at a predetermined position on the front surface of the device. In the state of FIG. 2B, the receiving member 120 covers the roll cover 201. When accessing the roll cover 201 for replacement of the roll R or the like, the user removes the second holding member 140, and places the receiving member 120 and the second holding member 140 on the drawer unit 150.

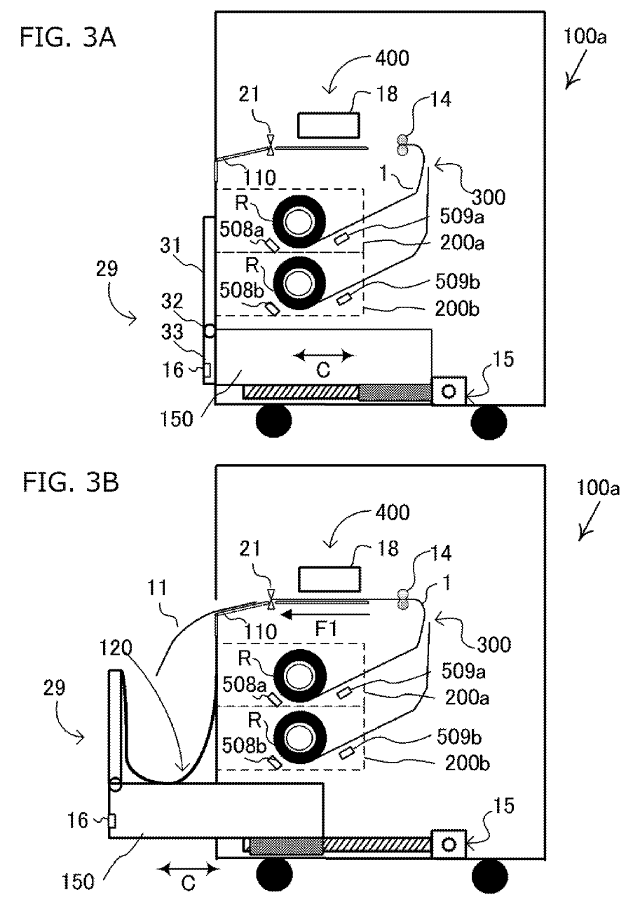

FIGS. 3A and 3B are schematic sectional views of the recording device 100, and correspond to an A-A section in FIG. 2B. FIG. 3A illustrates a state during the image non-recording, and FIG. 3B illustrates a state during the image recording. The drawer unit 150 on which the ejected sheet receiving unit 29 is mounted is guided by guide rails provided in a housing unit of the recording device 100 to be slidable in a direction of an arrow C. This allows the ejected sheet receiving unit 29 to move between a retracted position (housed position) inside the recording device 100 and a plurality of drawn-out positions that are drawn out from the recording device 100. Each of the plurality of drawn-out positions is a position for receiving the ejected sheet 1. The drawn-out positions are also referred to as a first position, and the retracted position is also referred to as a second position. The first position is provided in plurality.

A remaining amount detection unit 508 (508a and 508b) is disposed in the sheet feeding unit 200 (200a and 200b). The remaining amount detection unit 508 is a remaining roll amount detection sensor that detects the remaining amount of the sheet of the roll R remaining in the device body. Any method, such as an optical method and a weight-based method, can be employed for the remaining amount detection unit 508. A paper type detection unit 509 (509a and 509b) is also disposed in the sheet feeding unit 200 (200a and 200b). The paper type detection unit 509 is a medium type detection unit capable of detecting a paper type of the attached roll R. Any method, such as an optical method, can be employed for the paper type detection unit 509. Contents of detected paper types are not particularly limited, and for example, a sensor capable of detecting any characteristic, such as basis weight, a paper type, a surface property, and a thickness, according to a purpose may be used.

As illustrated in FIG. 3B, the sheet 1 drawn out from the roll R is conveyed along a sheet conveyance path by a conveyance unit 300. The conveyance unit 300 is a conveyance mechanism that includes a guide, a roller, and the like for conveying the sheet 1. The conveyance unit 300 conveys the drawn-out sheet 1 below the recording unit 400.

The recording unit 400 ejects ink from an ink-jet recording head 18 to record an image on the sheet 1 serving as a recording medium. The recording head 18 ejects ink from an ejection port using an ejection energy generating element, such as an electrothermal conversion element (heater) and a piezoelectric element. However, the recording head 18 is not limited to the inkjet type, nor is the image recording method for the recording unit 400 limited to one. For example, a serial-scan method, a full-line method, or the like may be used. In the case of the serial-scan method, an image is recorded by combining a conveyance operation of the sheet 1 and scanning, of the recording head 18, in a direction intersecting the conveyance direction of the sheet 1. In the case of the full-line method, an image is recorded while the sheet 1 is continuously conveyed using a long recording head 18 that extends in the direction intersecting the conveyance direction of the sheet 1.

The sheet 1 guided to the recording unit 400 is conveyed in a conveyance direction F1 by a pair of conveyance rollers 14. A cutter 21 and the sheet ejection unit 110 are arranged in this order on a downstream side of the recording head 18 in the conveyance direction F1. The sheet 1 after recording is conveyed to the front surface of the recording device through an upper side of the sheet ejection unit 110. When the image recording is finished, the sheet 1 is cut by the cutter 21, resulting in the recorded sheet 11. The recorded sheet 11 is ejected from the sheet ejection unit 110 to the outside of the device by its own weight. Thereafter, the recorded sheet 11 is received, in the direction of gravity, in the ejected sheet receiving unit 29 that is located downward.

An arrangement of the cutter 21 is not limited to a subsequent stage of the recording unit 400 in the conveyance direction. For example, the cutter 21 may be disposed at a preceding stage of the recording unit 400, or may be disposed on an upstream side or a downstream side of the pair of conveyance rollers 14. In a case where the cutter 21 is disposed at the preceding stage of the recording unit 400 or in the vicinity of the pair of conveyance rollers 14, the recorded sheet 11 is conveyed to the sheet ejection unit 110 by the drive of a motor 15 for the conveyance rollers included in the conveyance unit 300 or for sheet ejection.

The recording device 100 starts the image recording operation on the sheet 1 and drives the motor 15 based on setting information of the roll R and a print setting that are set in the recording device 100. The drawer unit 150 is moved to the front side of the device by the operations of a ball screw that changes the rotation of the motor 15 into linear motion and a moving mechanism including the guide rails that guide the drawer unit 150 in the front-rear direction. As a result, the ejected sheet receiving unit 29 moves to a sheet receiving position illustrated in FIG. 3B before the recorded sheet 11 is ejected. On the other hand, since the ejected sheet receiving unit 29 is housed during the image non-recording in FIG. 3A, the ejected sheet receiving unit 29 is not affected by dust and dirt.

The recording device 100 of the present embodiment includes an obstacle detection unit 16. The obstacle detection unit 16 has a function of detecting whether a person or an object that becomes an obstacle is present within a movement range of the ejected sheet receiving unit 29. The motor 15 is driven only when the obstacle detection unit 16 does not detect an obstacle. Alternatively, while the obstacle detection unit 16 is operated at all times, movement of the ejected sheet receiving unit 29 may be stopped immediately when an obstacle is detected during the movement. As the obstacle detection unit 16, an optical sensor, a sonar sensor, an ultrasonic sensor, or the like can be employed. In FIGS. 3A and 3B, the obstacle detection unit 16 is disposed in the ejected sheet receiving unit 29, but the disposed position is not limited thereto, and the obstacle detection unit 16 may be disposed anywhere as long as an obstacle in the movement range can be detected. After the set image recording operation is finished, the ejected sheet receiving unit 29 is moved to the arrangement of FIG. 3A by reversely rotating the motor 15, and is housed in the device.

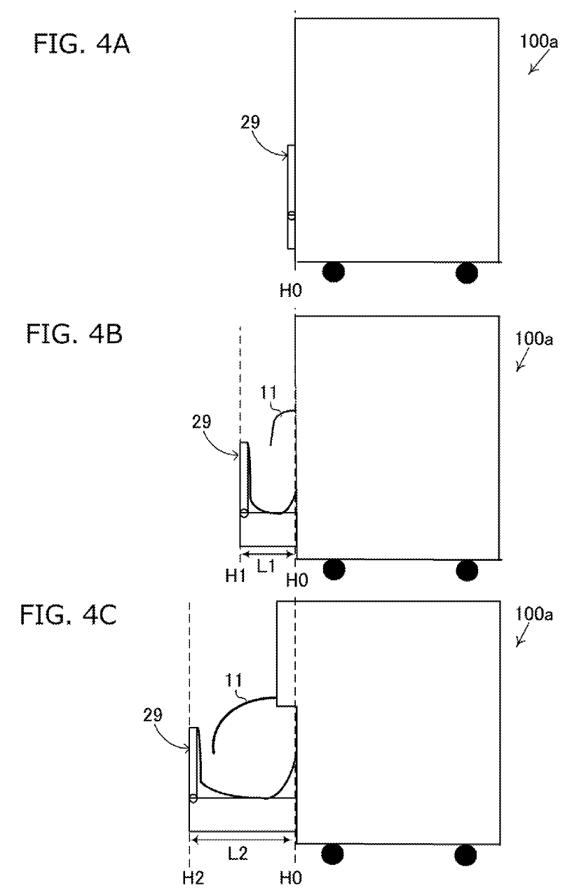

FIGS. 4A to 4C illustrate a plurality of possible drawn-out positions of the ejected sheet receiving unit 29. That is, the ejected sheet receiving unit 29 of the present embodiment has a plurality of positions capable of receiving the recorded sheet 11. For example, the ejected sheet receiving unit 29 is configured to be guided by the guide rails provided on side surfaces inside the device body to be allowed to move along the guide rails by the drive of the motor. Note that the guide rails may be configured to support the drawer unit 150 from below, or may be configured to support the drawer unit 150 from side surfaces.

In FIGS. 4A to 4C, the position of the front surface of the device body 100a in a drawing-out direction is designated as H0. In FIG. 4A, the ejected sheet receiving unit 29 is housed at the retracted position inside the device body, and a drawn-out amount (movement amount) L0 is zero. At a receiving position in FIG. 4B, a position of the ejected sheet receiving unit 29 is H1 and the drawn-out amount is L1. At a receiving position in FIG. 4C, the position of the ejected sheet receiving unit 29 is H2 that is different from H1, and the drawn-out amount is L2 that is larger than L1. As the recording device 100 is viewed from above to below in the direction of gravity, when the drawn-out amount is L2, the area of the receiving member 120 is larger than that when the drawn-out amount is L1, and the area capable of receiving the recorded sheet 11 is larger. As the recording device 100 is viewed from the side, when the drawn-out amount is L2, the volume that allows the ejected sheet receiving unit 29 to receive the sheet is larger than that when the drawn-out amount is L1.

When the drawn-out amount is small with respect to the size of the recorded sheet 11, the recorded sheet 11 may overflow from the ejected sheet receiving unit 29 and protrude to the outside of the device, which possibly leads to contamination or a scratch. Hence, the drawn-out amount is required to be sufficiently large enough to receive the entire recorded sheet 11. On the other hand, when the drawn-out amount is large with respect to the size of the recorded sheet 11, no problem arises in receiving the recorded sheet 11. However, if the drawn-out amount is unnecessarily increased, there is a risk of hindering passage of the user or increasing power consumption during the drive of the motor 15. Thus, it is more preferable to set the drawn-out amount according to the size of the recorded sheet 11.

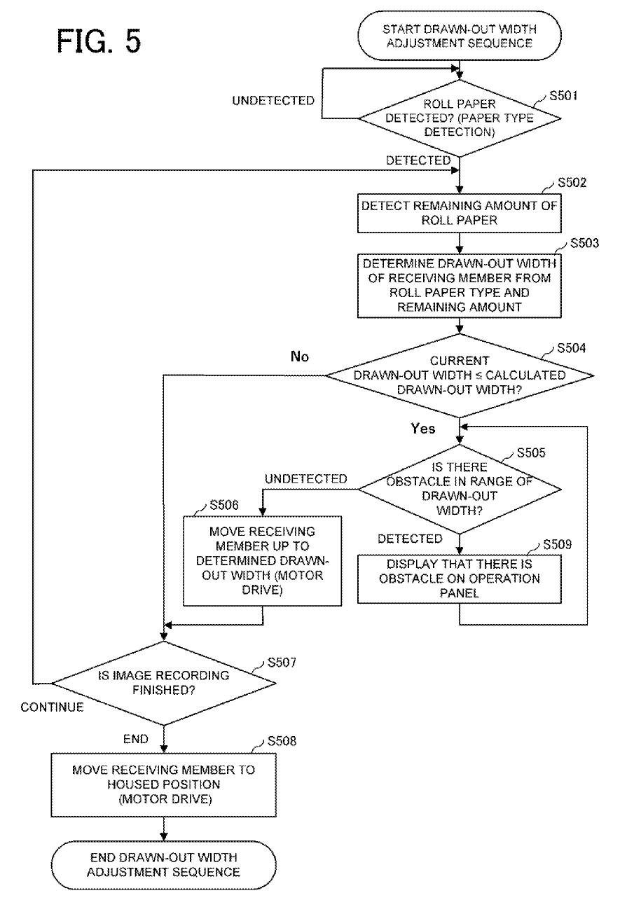

FIG. 5 is a flowchart illustrating a drawn-out width adjustment sequence for setting the drawn-out positions of the ejected sheet receiving unit 29 in the image recording operation. In FIG. 5, a desired position is selected from among the plurality of drawn-out positions of the ejected sheet receiving unit 29 based on information set by the user or the like, and a drawn-out width for moving the ejected sheet receiving unit 29 to the selected position is determined. A procedure for determining the drawn-out position will be described below with reference to FIGS. 4A to 4C and FIG. 5.

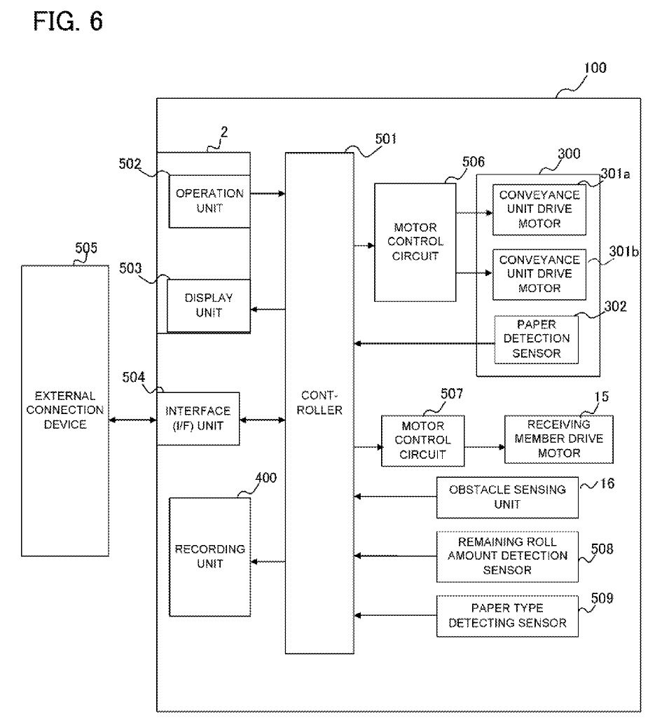

FIG. 4A illustrates a state before the image recording operation of the recording device 100 is started. At this time, the ejected sheet receiving unit 29 is housed inside the recording device 100 (retracted position). The flow of FIG. 5 starts when the recording device 100 receives a job of the image recording started by an operation of an external connection device 505 or the operation panel 2. Note that the flow of FIG. 5 is typically achieved by a controller 501 (described later with reference to FIG. 6) or the like functioning as a control unit and controlling components of the recording device 100.

First, in step S501, the control unit sets paper type information of the roll R set in the recording device 100. Note that the “paper type” is referred to here, but the roll R may be a recording medium other than paper. When a recording medium other than paper is also included, the paper type information may be referred to as “medium type information”. At this time, the control unit sets the paper type information based on at least one piece of preset setting information, detection information of the paper type detection unit 509 that is disposed inside the recording device 100, and input information of the external connection device 505 (PC, bar code, or the like) that is connected to the recording device 100. Setting of the paper type information is performed, for example, by storing information in a memory included in the controller 501.

The control unit repeats the processing of step S501 until the information of the paper type is set. At this time, notification indicating that the paper type information is not set may be given to the operation panel 2 or an externally connected device. Note that the paper type detection unit 509 is not an indispensable component, and the user may input the paper type. In this case, step S501 is omitted.

When the paper type information is set in the recording device 100, the processing proceeds to step S502, and the control unit acquires remaining amount information of the roll R in the recording device 100. The remaining amount information can be acquired from, for example, remaining amount information of the roll R obtained from setting information of the recording device 100. When the image recording is in operation, the remaining amount information of the roll R can be calculated by updating a current remaining amount of the roll R using an amount of paper used in the image recording operation. Alternatively, detection information of the remaining amount detection unit 508 that is disposed inside the recording device 100 may be used.

Subsequently, in step S503, the control unit estimates a curled shape and a weight of the sheet 1 from the type of the roll paper and the remaining amount of the paper. For example, a curling behavior of the sheet 1 changes depending on the type and the remaining amount of the roll paper. Then, the drawn-out width of the ejected sheet receiving unit 29 required when the recorded sheet 11 is ejected from a sheet ejection port is determined using the estimation information. In general, it is preferable that the larger the size of the recorded sheet 11, the longer the length of the recorded sheet 11 in the conveyance direction, and the heavier the weight of the recorded sheet 11, the larger the drawn-out width. When the sheet is of a type subject to easy curling, the sheet can be accommodated in a small drawn-out width. The control unit calculates the drawn-out width by a method for substitution into a mathematical expression or reference to a table, for example, based on the paper type, a value, such as the remaining amount, or the like.

Further, since the amount of curl and the curled shape change according to an amount of ink when the recording is performed on the roll paper, the amount of curl and the curled shape can also be calculated based on image data at the time of the image recording.

In the present embodiment, the drawn-out width is set as two stages of the case of FIG. 4B and the case of FIG. 4C, but the number of stages may be increased, or the drawn-out width may be stepless. When the drawn-out width is stepless, “select” of the drawn-out width in the following flow is read as “determine” of the drawn-out width.

When the drawn-out width is selected, in step S504, a current drawn-out width of the ejected sheet receiving unit 29 is compared with the drawn-out width calculated this time in step S503. If the current drawn-out width is equal to or larger than the drawn-out width calculated this time (S504=NO), the ejected sheet receiving unit 29 is not required to be moved, and thus the processing proceeds to step S507.

On the other hand, if the drawn-out width calculated this time is larger than the current drawn-out width (S504=YES), the processing proceeds to step S505. In step S505, the control unit checks, using the obstacle detection unit 16, whether there is an obstacle in a range of drawing out the ejected sheet receiving unit 29. When there is no obstacle (undetected), the motor 15 is activated to move the ejected sheet receiving unit 29 to the selected position. Thereafter, the operations of steps S502 to S507 are repeated until the image recording operation is finished. On the other hand, when there is an obstacle (detected), the processing proceeds to step S509, a notification indicating that there is an obstacle and the ejected sheet receiving unit 29 is required to move is displayed on a display unit 503 of the operation panel 2, and the processing waits until the obstacle is eliminated from the range.

In step S507, the control unit determines whether the image recording operation of the sent print job is finished. When the recording operation is finished, the processing proceeds to step S508, and the motor 15 is reversely rotated to move the ejected sheet receiving unit 29 to the retracted position inside the device. Note that whether or not to house the ejected sheet receiving unit 29 is displayed on the display unit 503 before the ejected sheet receiving unit 29 is housed, and the user may be prompted to select. In this case, when the user selects to house the ejected sheet receiving unit 29, the ejected sheet receiving unit 29 is moved to the retracted position. When the movement is finished, this sequence ends.

In the present embodiment, the drawn-out width adjustment sequence in the sent print job unit is illustrated as an example. However, when the recording device 100 continuously receives print jobs using the same roll R, it is not necessary to finish the image recording operation for each print job in step S507. In this case, it is possible to continue the drawn-out width adjustment sequence until a print job using a different roll R is received, until there is no print job being received by the recording device, or until there is no remaining amount of the roll R and replacement is performed.

FIG. 6 is a block diagram illustrating a hardware configuration of the recording device 100 according to the present embodiment. The operation panel 2 includes an operation unit 502 that receives an operation of the user and the display unit 503 that displays information to the user. The user can input size designation of the sheet 1, online-offline switching, various commands for the recording device 100, and the like to the recording device 100 through the operation unit 502. In addition, the display unit 503 displays various types of set data, notification information from the controller 501, and the like.

An interface unit (I/F unit) 504 is used for connection to the external connection device 505 to the recording device 100, and is used to enable various types of setting data to be set from the external connection device 505 (including a PC, a bar code reader, and the like), together with the operation unit 502.

The controller 501 performs control on components of the entire device, and can use an information processing device including a processor, a memory, and the like, a control circuit, and the like. The controller 501 determines a control signal timing for driving the motor and a control signal timing for the recording unit 400 based on paper detection information from a paper detection sensor 302, and sends signals.

Ink ejection in the image recording operation is performed by the controller 501 sending a control signal to the recording unit 400 when the recorded sheet 11 is conveyed below the recording unit 400. A motor control circuit 506 determines a control signal for a motor to be driven in each drive unit based on the paper detection information and sends the control signal to a conveyance unit drive motor 301a to perform the drive. Thus, the conveyance unit 300 includes at least one conveyance unit drive motor 301 (301a, 301b...) and at least one paper detection sensor for detecting a paper end portion or a paper jam.

The controller 501 generates a control signal according to the information of the remaining amount detection unit 508 and the information of the paper type detection unit 509, from the timing when the image recording operation is started by the input from the operation unit 502 or the external connection device 505, and sends the control signal to a motor control circuit 507. This causes the motor 15 to be driven. The motor 15 drives, for example, the ball screw for drawing out the ejected sheet receiving unit 29. In addition, the controller 501 receives a detection result, from the obstacle detection unit 16, for checking whether there is an obstacle within the range of drawing out the ejected sheet receiving unit 29 before the motor 15 is driven.

### Second Embodiment

In the present embodiment, an application example in a recording device 100 in which an ejected sheet receiving unit 29 having a basket shape is connected to a front surface of the recording device 100, will be given. Hereinafter, differences from the first embodiment will be mainly described, and contents similar to those of the first embodiment will be simplified.

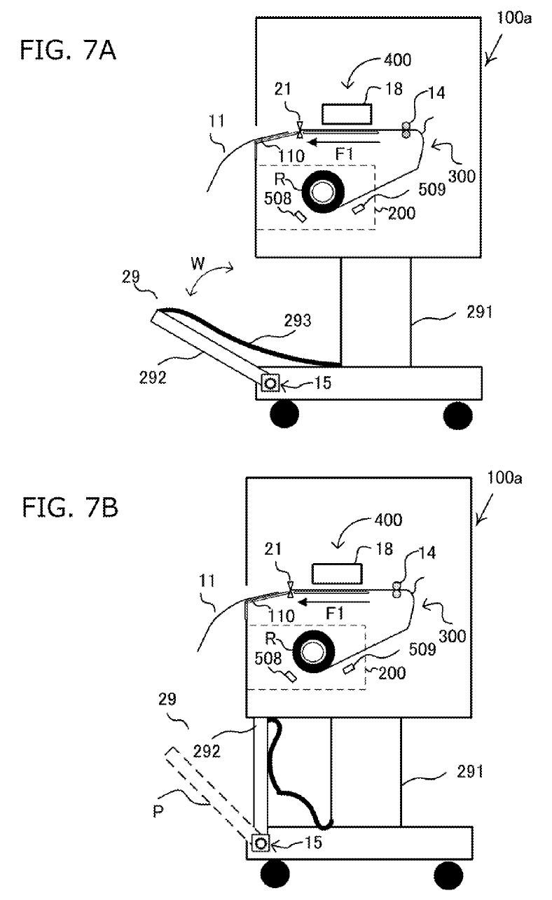

As illustrated in sectional views of FIGS. 7A and 7B, the recording device 100 of the present embodiment includes a sheet feeding unit 200 that receives a roll R and supplies the roll R to a recording unit 400, and the ejected sheet receiving unit 29 having a basket structure. A device body 100a is disposed on an upper portion of a stand 291 that is coupled to the ejected sheet receiving unit 29.

FIG. 7A is the schematic sectional view of the recording device 100 during sheet ejection after image recording. In the ejected sheet receiving unit 29 of the present embodiment, a frame unit 292 constituting the basket structure is provided with a receiving member 293 that has flexibility and receives a recorded sheet 11. When a motor 15 is driven to rotate by a command from a controller 501 serving as the control unit, the frame unit 292 is brought close to or separated from the stand 291 (direction of an arrow W). This allows a position of the ejected sheet receiving unit 29 to be changed. The frame unit 292 having a planar shape is pivotable around a pivot shaft with respect to the device body. The frame unit 292 has, on one end side, a moving side (first holding member) that is moved by the drive of the motor 15, and a fixed side (second holding member) that is located on the other end side (opposite side) of the frame unit 292 and is connected to the device body 100a. The fixed side is provided downward in the direction of gravity.

In FIG. 7A, the ejected sheet receiving unit 29 is located at a position capable of receiving the recorded sheet 11. The position of the frame unit 292 indicated by solid lines in FIG. 7B is a position when the ejected sheet receiving unit 29 is housed at a retracted position while the recording device 100 does not perform image recording.

As indicated by a broken line P in FIG. 7B, a state in which a drawn-out amount of the frame unit 292 is smaller than that in the state of FIG. 7A, may be provided. In this case, similarly to the first embodiment, the controller 501 calculates a drawn-out amount of the ejected sheet receiving unit 29, and determines the position of the frame unit 292 according to the drawn-out amount. Then, an angle of the pivot by the drive unit is determined so as to achieve the position of the frame unit 292.

Note that the disposed position and the drive location of the motor 15 are not limited thereto, nor is the drive method limited to using the motor 15. The configuration may be such that a mechanism for stepwisely fixing the ejected sheet receiving unit 29 is installed to a shaft portion and is driven.

### Third Embodiment

In the present embodiment, another application example in a recording device 100 in which an ejected sheet receiving unit 29 having a basket shape is connected to a front surface of the recording device 100, will be given. Hereinafter, differences from the first and second embodiments will be mainly described, and similar contents will be simplified.

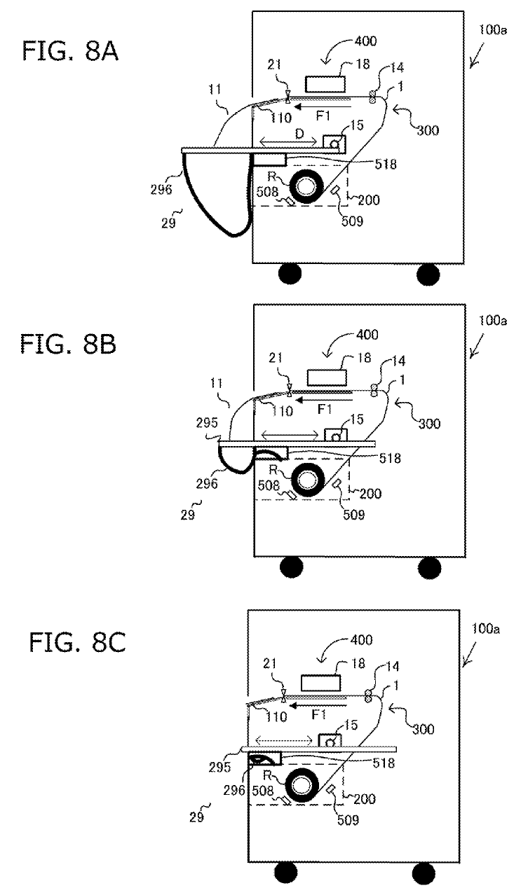

FIGS. 8A to 8C are sectional views of the recording device 100 including the ejected sheet receiving unit 29 having a basket shape on the front surface of the recording device 100. The ejected sheet receiving unit 29 includes shafts 295 that are movable in a direction of an arrow D by the drive of a motor 15, and a receiving member 296 that has flexibility and is suspended by tension between a front surface side of a device body 100a and one end sides of the shafts 295. Two shafts 295 are provided in parallel in a direction along an arrow F1 in the conveyance direction, and the two shafts 295 operate in cooperation with each other. As the recording device 100 is viewed from above, the receiving member 296 is visible between the two shafts 295. An ejected recorded sheet 11 passes between the two shafts 295 to fall in a receiving surface of the receiving member 296. The ejected sheet receiving unit 29 of the present embodiment can be configured by, for example, a combination of a ball screw and a gear driven by the motor 15. The receiving member 296 of the present embodiment is wound as the state changes from FIG. 8A to FIG. 8C.

FIG. 8A illustrates a state in which the ejected sheet receiving unit 29 is fully drawn out. FIG. 8B illustrates a state in which a drawn-out amount is smaller than that in the state of FIG. 8A. In FIG. 8B, a part of the receiving member 296 is wound by a winding unit 518. The winding unit 518 is a mechanism that winds and receives the receiving member 296 correspondingly to the state of drawing out the ejected sheet receiving unit 29. FIG. 8C illustrates a state in which the ejected sheet receiving unit 29 is housed in the device body 100a, and in FIG. 8C, the receiving member 296 is entirely wound around the winding unit 518. In the present embodiment, similarly to the first and second embodiments, a controller 501 calculates the drawn-out amount of the ejected sheet receiving unit 29, and determines feeding amounts of the shafts 295 according to the drawn-out amount.

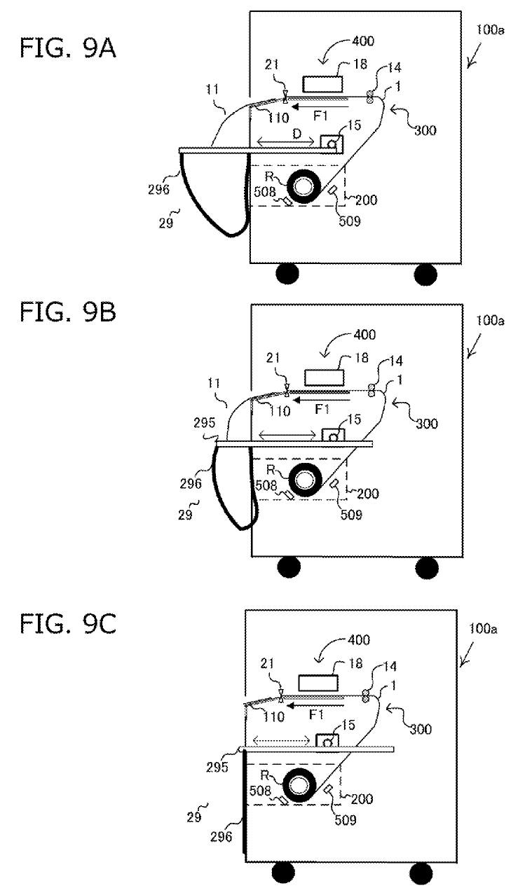

FIGS. 9A to 9C illustrate another example of the present embodiment. As illustrated in FIGS. 9B and 9C, in this example, the receiving member 296 hangs downward as the ejected sheet receiving unit 29 is housed.

As described above, according to the embodiments of the present specification, the ejected sheet receiving unit 29 is moved in conjunction with the image recording operation, and moved to an optimum position in order to receive the recorded sheet 11 to be ejected. This allows the recorded sheet 11 ejected from the sheet ejection unit 110 to be automatically received in the ejected sheet receiving unit 29. As a result, it is possible to avoid contamination or a scratch on the recording medium caused by forgetting to draw out the ejected sheet receiving unit 29 by manual operation or performing the image recording operation at an inadequate drawn-out position. Further, when the image recording is not performed in the recording device 100 and the recording medium is not ejected, the ejected sheet receiving unit 29 is housed, so that the influence of dust and the like can be avoided.

According to the present disclosure, it is possible to provide the recording device in which the ejected sheet receiving unit that receives the ejected recording medium is moved by the drive.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221877, filed December 18, 2024, which is hereby incorporated by reference herein in its entirety.

What is claimed is:

1. A recording device comprising:
a recording unit configured to record an image on a recording medium drawn out from a roll;
an ejection port through which the recording medium on which an image is recorded by the recording unit is ejected;
a sheet-like receiving member configured to receive the recording medium ejected from the ejection port;
a moving mechanism configured to move the receiving member to a first position at which the receiving member receives the recording medium and a second position at which the receiving member does not receive the recording medium; and
a control unit configured to perform control to move the receiving member to the first position and the second position by the moving mechanism.

2. The recording device according to claim 1, wherein
the first position is provided in plurality, and
the control unit acquires information on the recording medium to be ejected, and determines the first positions based on the information.

3. The recording device according to claim 1, further comprising a cutter configured to cut the recording medium on which an image is recorded by the recording unit, wherein
the recording medium cut by the cutter is received by the receiving member at the first position.

4. The recording device according to claim 2, wherein the control unit determines the first position based on medium type information indicating a type of the recording medium.

5. The recording device according to claim 4, further comprising a medium type detection unit configured to detect the medium type information.

6. The recording device according to claim 4, wherein the control unit determines the first position by calculating a curled shape of the recording medium to be ejected based on the medium type information.

7. The recording device according to claim 6, further comprising a remaining amount detection unit configured to detect a weight of the recording medium, the weight remaining in a device body, wherein
the control unit calculates the curled shape of the recording medium to be ejected further based on the weight detected by the remaining amount detection unit.

8. The recording device according to claim 1, wherein the control unit controls the receiving member to be brought to the second position during image non-recording when the recording unit does not record the image, and moves the receiving member to the first position when an image recording operation by the recording unit is started.

9. The recording device according to claim 1, wherein
the receiving member is a sheet-like member having flexibility,
the recording device further comprises a first holding member configured to hold one end side of the receiving member and a second holding member configured to hold another end side of the receiving member and to be attached to a device body, and
when the control unit moves the receiving member, the control unit changes a distance between the first holding member and a device body.

10. The recording device according to claim 1, wherein the receiving member is capable of being housed inside a device body and is movable along a guide rail.

11. The recording device according to claim 10, wherein the control unit changes a position by changing a movement amount of the receiving member.

12. The recording device according to claim 1, further comprising a frame unit having a fixed side that is connected to a device body and a moving side that is located on an opposite side of the fixed side, wherein
the receiving member is connected to the fixed side and the moving side, and
the control unit brings the frame unit close to the device body or separates the frame unit from the device body, by pivoting the frame unit around a pivot shaft that is provided on a side of the fixed side.

13. The recording device according to claim 12, wherein the control unit changes a position of the receiving member by changing an angle of the pivot of the frame unit.

14. The recording device according to claim 1, further comprising a shaft on which the receiving member is suspended by tension, wherein
the control unit is capable of drawing out the shaft from a device body in a direction different from a direction of gravity, and moves a position of the receiving member by controlling a drawn-out amount of the shaft.

15. The recording device according to claim 1, further comprising an obstacle detection unit configured to detect whether an obstacle is present within a movement range of the receiving member, wherein
the control unit does not move the receiving member when the obstacle is detected.
